(19) United States
(12) Patent Application Publication
(10) Pub. No.: US 2016/0070495 A1
(43) Pub. Date: Mar. 10, 2016

(54) LOGICAL REPLICATION MAPPING FOR ASYMMETRIC COMPRESSION

(71) Applicant: NetApp, Inc., Sunnyvale, CA (US)

(72) Inventors: Subramaniam Periyagaram, Campbell, CA (US); Sandeep Yadav, Santa Clara, CA (US); Blake H. Lewis, Los Altos, CA (US); Rickard E. Faith, Hillsborough, NC (US)

(21) Appl. No.: 14/929,018

(22) Filed: Oct. 30, 2015

Related U.S. Application Data
(63) Continuation-in-part of application No. 14/286,900, filed on May 23, 2014.
Application No. 14/286,900 is a continuation of application No. 13/099,283, filed on May 2, 2011, now Pat. No. 8,745,338.

(51) Int. Cl. G06F 3/06; G06F 12/02; G06F 12/12

(52) U.S. Cl. CPC G06F 3/0619; G06F 12/121; G06F 12/023; G06F 3/0641; G06F 3/065; G06F 3/067; G06F 2212/1044; G06F 2212/69

(57) ABSTRACT

A system and method for logically organizing compressed data. In one aspect, a destination storage server receives a write request that includes multiple data blocks and specifies corresponding file block numbers. An extent-based file system executing on the storage server accesses intermediate block entries that each associates one of the file block numbers with a respective extent block number. The file system, in cooperation with a compression engine, compresses the data blocks into a set of one or more compressed data blocks. The file system stores the compressed data blocks at physical locations corresponding to physical block numbers and allocates, within an extent map, pointers from an extent ID to the extent block numbers, and pointers from the extent ID to the physical block numbers.

### PRIORITY CLAIM

This application is a continuation-in-part of U.S. patent application Ser. No. 14/286,900, filed on May 23, 2014, titled “OVERWRITING PART OF COMPRESSED DATA WITHOUT DECOMPRESSING ON-DISK COMPRESSED DATA,” which is a continuation of U.S. patent application Ser. No. 13/099,283, filed on May 2, 2011, titled “OVERWRITING PART OF COMPRESSED DATA WITHOUT DECOMPRESSING ON-DISK COMPRESSED DATA,” the content of both of which is incorporated by reference herein.

### TECHNICAL FIELD

The disclosure generally relates to the field of logical replication of stored data, and more particularly to a data storage reference architecture that enables efficient replication between storage platforms that may utilize storage efficiency mechanisms such as data compression and/or deduplication.

### BACKGROUND

File systems are used in data processing and storage systems to establish naming conventions, protocols, and addressing that determine how data is stored and retrieved. A key function of most file systems is separating data into individually addressable portions and naming each portion to enable access to each individual portion. A file system may be implemented in a dedicated storage configuration in which the file system represents a single namespace tree and retains exclusive management of one or more physical storage resources (e.g., disks, SSDs, and/or partitions thereof) which provide the underlying persistent storage for the file system. The controlling file system determines the allocation of individual storage blocks on such dedicated storage configurations.

Continual growth in storage device capacities and increasing prevalence of multi-client access to large data stores has rendered dedicated file system storage an increasingly inefficient storage management system. Growing storage capacities tend to create a need for larger file systems on larger storage allocation groups to optimize performance and storage capacity utilization. However, larger scale storage capacity and correspondingly larger centralized storage management pose issues for end user clients which may rely on or otherwise benefit performance or security wise from managing particular application data sets as logical units determined by the size and characteristics of the respective data sets.

Virtualization is utilized to abstract physical resources and to control allocation of logical resources independently of their underlying implementation. For storage systems, file volumes are virtualized to add a level of indirection between client-accessible volumes and the underlying physical storage resources. The resulting virtual file volumes may be managed independent of lower storage layers, and multiple volumes can be generated, deleted, and reconfigured within a same physical storage volume. Storage volume virtualization is achieved, at least in part, by using physical aggregate and file system layer referencing that are mutually mapped via a logical/virtual volume layer. While improving many aspects of application data storage and management, the data referencing and mapping incident to virtualization may create inefficiencies relating to the manner in which stored data is logically replicated, such as from one or more source storage volumes to one or more destination storage volumes.

### BRIEF DESCRIPTION OF THE DRAWINGS

Aspects of the disclosure may be better understood by referencing the accompanying drawings.

FIG. 1 is a block diagram depicting a storage system configured to logically organize compressed data and implement logical replication in accordance with an aspect;

FIG. 2 is a conceptual diagram illustrating an extent-based pointer structure that may be utilized to support asymmetric compression during logical replication in accordance with an aspect;

FIG. 3 is a block diagram illustrating source and destination storage servers that may employ an extent-based file system in accordance with an aspect;

FIG. 4A is a block diagram depicting an intermediate block containing intermediate block entries and an extent-to-PVBN map that includes entries corresponding to a physical extent having compressed data blocks in accordance with an aspect;

FIG. 4B is a block diagram illustrating an intermediate block containing intermediate block entries and an extent-to-PVBN map that includes entries corresponding to a compressed physical extent that has been partially overwritten in accordance with an aspect;

FIG. 5 is a flow diagram depicting operations and functions that may be implemented during a data write in accordance with an aspect;

FIG. 6 is a flow diagram depicting operations and functions that may be implemented during logical replication of a source data set to a compressed destination data set in accordance with an aspect; and

FIG. 7 depicts an example computer system that includes an extent-based file system in accordance with an embodiment.

### DESCRIPTION

The description that follows includes example systems, methods, techniques, and program flows that embody aspects of the disclosure. However, it is understood that this disclosure may be practiced without one or more of these specific details. In other instances, well-known instruction instances, protocols, structures and techniques have not been shown in detail in order not to obfuscate the description.

Overview

Aspects of the disclosure include implementation of a file system naming schema that enables inline and/or background compression of data during or following logical replication of the data from a source volume to a destination volume. The naming schema may include an intermediate block containing multiple entries that each correspond to a logical block, referred to herein as an extent block. The intermediate block entries contain extent block numbers associated with a logical extent that is resolved by a mapper to a physical extent comprising one or more data blocks addressed by corresponding physical volume block numbers. In an aspect, the intermediate blocks disclosed herein may comprise indirect blocks in an inode structured file system.

Each of the logical extents may be processed by and within a logical volume that may form a file system instantiation within a storage server system. The logical extents may reference multiple fixed-size data blocks that may or may not be stored on contiguous physical storage blocks. The indirect blocks may comprise fixed or variable length data structures each having an extent ID that is unique within a given volume. In one aspect, an intermediate block further includes address pointers, such as in the form of extent block numbers, which collectively reference ranges and subranges of contiguous data blocks to which the logical extents are referenced.

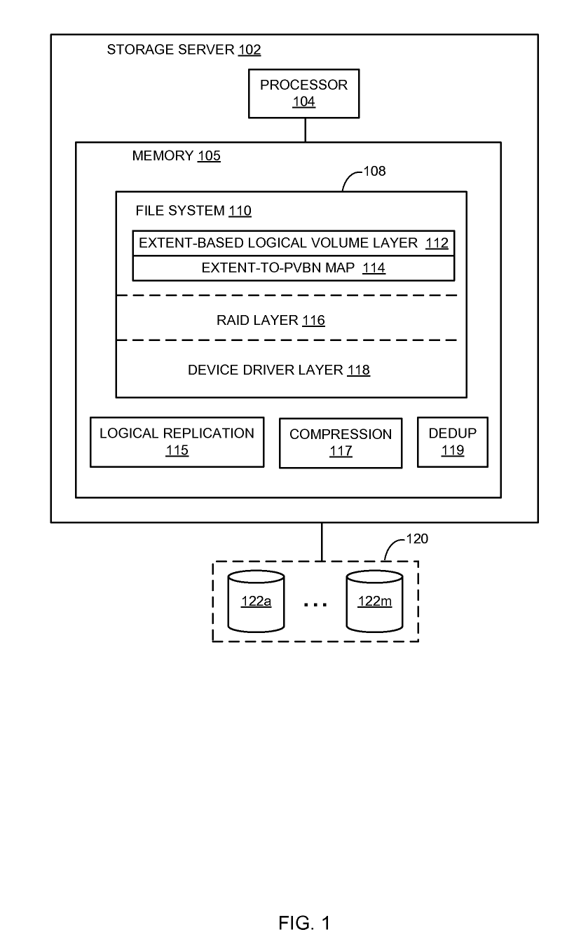

FIG. 1 is a block diagram depicting a storage system configured to logically organize compressed data and implement logical replication. As shown in FIG. 1, a storage server 102 is configured with hardware and software components for storing and providing client access to large data sets. While not depicted for purposes of simplicity, storage server 102 is typically connected to one or more storage clients via an interconnect or over a network such as a local or wide area network. Storage server 102 may be a file server that provides centralized and shared access to data stored as computer files. Processing of storage management functions as well as client requests is performed by a processor 104 that is connected to a main memory 105. In one aspect, the hardware and software components of storage server 102 may be configured as a primary storage server that actively processes storage client requests. For instance, storage server 102 may be configured to receive and respond to various read and write requests directed to stored or to-be-stored data. In another aspect, storage server 102 may be configured as a backup storage server that provides data backup, such as via data replication, for a primary storage server.

Storage server 102 is communicatively coupled with a storage subsystem 120 comprising, in part, multiple storage devices 122a-122m and storage controller functionality (not depicted). Storage devices 122a-122m may be, for example, magnetic or optical disks or tape drives, non-volatile solid-state memory, such as flash memory, or any combination of such mass storage devices. Data stored within storage subsystem 120 is typically organized as one or more physical storage volumes comprising respective storage space allocated from storage devices 122a-122m that defines a logical arrangement of physical storage space within a storage aggregate. The storage devices, or portions thereof, within a given physical volume may be configured into one or more groups, such as Redundant Array of Independent Disks (RAID) groups that can be accessed by storage server 102 using, for instance, a RAID algorithm.

Storage server 102 includes a storage operating system (OS) 108 that implements an extent-based file system architecture to manages storage of data within storage subsystem 120, service client requests, and perform various other types of storage related operations. Storage OS 108 comprises a series of software layers executed by processor 104 to provide data paths for clients to access stored data using block and/or file access protocols. The layers include a file system 110, a RAID system layer 116, and a device driver layer 118. File system 110 is essentially a volume that may be combined with other volumes (file system instantiations) onto a common set of storage within a RAID level storage aggregate. RAID system layer 116 builds a RAID topology structure for the aggregate that guides each volume when performing write allocation. The RAID layer also presents a PVBN-to-disk block number (DBN) mapping for accessing blocks on physical storage media.

To provide for stored data backup, storage server 102 also includes a logical replication application 115 that replicates data at the file and file block level. For instance, if storage server 102 is configured as a primary server that actively handles client requests, logical replication application 115 may be programmed to send portions of modified data to a corresponding backup-side replication application executing from a backup storage server. Such replication may be performed based on periodic or asynchronous file system consistency points. If storage server 102 is configured as a backup server, logical replication application 115 may be programmed to receive and process replication requests which typically include write requests to store modified or new data as an archive version.

As depicted, storage OS 108 implements file system 110 to logically organize the data stored on storage subsystem 120 as a hierarchical structure of file system objects such as directories and files. In this manner, each file system object may be managed and accessed as a set of data structures such as on-disk data blocks that store user data. The data blocks may be organized within logical volumes within a logical volume layer wherein each logical volume may constitute an instantiation of a user file system including the file system management code and structures, as well as directories and files. Within a logical volume layer, each volume constitutes a respective volume block number space that is maintained by file system 110. File system 110 assigns a file block number for each data block in the file as offset to arrange the file block numbers in the correct sequence. File system 110 allocates sequences of file block numbers for each file and assigns volume block numbers across each volume address space. In this manner, file system 110 organizes the “on-disk” data blocks within the volume block number space as a logical volume.

Storage servers often include storage efficiency components that reduce a physical data storage footprint and thus conserve physical storage space and reduce network traffic incident to logical replication. To enable such storage efficiency features, storage server 102 further includes a compression module 117 and a deduplication module 119. While depicted as distinct blocks in the depicted aspect, compression module 117 and/or deduplication module 119 may be incorporated within or otherwise logically associated with storage OS 108 and/or logical replication application 115.

The primary function of compression module 117 is to compress data within a file across two or more data blocks. To accomplish this, compression module 117 evaluates data within a specified number of data blocks (compression group) and, if sufficient bit-level patterns are repeated, the compression group is compressed into number of physical data blocks that is less than number of corresponding logical blocks. In one aspect, compression module 117 performs inline compression in which compression groups are compressed prior to being written to storage subsystem 120. In another aspect, compression module 117 performs background compression in which compression groups are compressed following initially being written to storage subsystem 120.

Deduplication module 119 provides an alternative or complementary storage efficiency mechanism that eliminates copies of the same data unit and allocates pointers to the retained copy. For example, block-level deduplication entails identifying data blocks containing identical data, removing all but one copy across a volume, and allocating pointers to the retained block.

Logical replication, such as performed by logical replication application 115, differs from physical replication in which the entire data set comprising the file system, including all data and all logical to physical mapping are preserved from the source to the destination server. Logical replication entails a file system level transfer of file system objects such as files, directories, and file block numbers from the source logical volume to the destination logical volume. Storage efficiency mechanisms such as compression and/or deduplication may be performed with logical replication to reduce storage space consumption on the destination and to reduce network traffic. However, for conventional file systems that implement logical volumes, the logical-to-physical volume mapping places a substantial performance penalty on logical replication due to the loss of logical-to-physical address mapping that occurs during compression. Such loss of mapping results in the need, for example, to uncompress data blocks belonging to a compression group prior to overwriting a portion of that compression group.

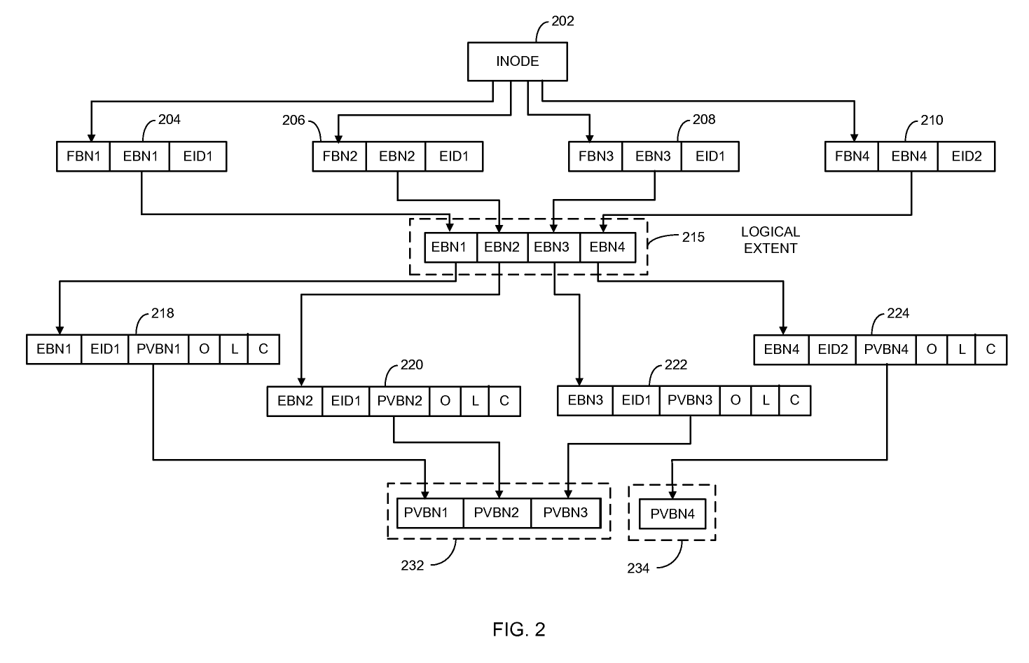

As further depicted in FIG. 1, file system 110 is configured with an extent-based logical volume layer 112 and an extent-to-pvbn map layer 114 that implement an extent-based logical-to-physical block mapping architecture. As described in further detail with reference to FIGS. 2-6, the extent-based logical volume layer 112 in combination with extent-to-pvbn map layer 114 enables logical replication to be performed when compression and/or deduplication are enabled on the backup (destination) server without the need to inflate the data on the destination server.

In one aspect, file system 110 implements a fixed block size, inode pointer structure for organizing access to logical and physical blocks. The inode pointer structure employs intermediate blocks in the form of indirect blocks that map file block numbers to respective logical extents comprising extent blocks addressed by extent block numbers. The architecture further includes a layer of extent blocks comprising extent block entries that may extent block numbers to physical block extents that are uniquely identified by an extent ID.

In one aspect of the present disclosure, data is stored in the form of volumes, where each volume contains one or more files and directories. As utilized herein, an aggregate refers to a pool of storage, which combines one or more physical storage devices (e.g., disks, SSDs) or parts thereof into a single logical storage object. An aggregate contains or provides storage for one or more other logical data sets at a higher level of abstraction, such as volumes. An aggregate uses a physical volume block number (PVBN) space that defines the storage space of blocks provided by the storage devices of the physical volume. Each volume uses a logical volume block space to organize those blocks into one or more higher level objects, such as files and directories. A PVBN, therefore, is an address of a physical block in the aggregate. The present disclosure describes a logical block type that is extent-based and mapped to PVBNs in a manner that enables transactional decoupling of the physical block mapping corresponding to logical extents processed at a logical volume level.

FIG. 2 is a conceptual diagram illustrating an extent-based pointer structure that may be utilized to support asymmetric compression during logical replication in accordance with an aspect. The depicted structure is for a file that has an assigned inode 202, which references Level 1 (L1) indirect block entries 204, 206, 208, and 210. Each of indirect block entries 204, 206, 208, and 210 contain extent block numbers EBN1, EBN2, EBN3, and EBN4, respectively. At the logical volume level, EBN1, EBN2, EBN3, and EBN4 form a logical extent 215 that may be accessed at the file level by using the FBNs contained in inode 202 as keys to search an indirect block containing each of entries 240, 206, 208, and 210. In one aspect, an EBN is a logical block number in a volume, which is a virtual number for addressing a respective L0 data block that is physically stored.

Each of the EBNs is further associated within each of the indirect block entries 204, 206, 208, and 210 with an extent ID that is unique within a given aggregate. As shown in FIG. 2, EBN1, EBN2, and EBN3 are associated within their respective indirect block entries with EID1 and EBN4 is associated within its indirect block entry with EID2. In one aspect, an extent ID is a physical extent identifier that is processed by an extent-to-PVBN map to PVBNs corresponding to physical blocks logically arranged in an aggregate. FIG. 2 depicts extent-to-PVBN map entries 218, 220, 222, and 224 that correspond to (are pointed to) the EBNs contained within indirect blocks 204, 206, 208, and 210. Each of map entries 218, 220, 222, and 224 includes an EBN field containing a multi-bit EBN that is logically associated with the EID stored within an EID field. Each of the map entries further includes a PVBN field containing a PVBN for a particular data block. Each of the map entries further includes an offset field, an extent length field, and a compression flag. The offset field value specifies the offset, in blocks, of a given block within an extent. The length field specifies the total length of the extent (all blocks within an extent). The compression flag may be a single bit that indicates whether or not the extent is compressed. The extent-to-PVBN map uses the EID to map its corresponding associated EBN to a PVBN at the extent-to-map layer rather than the logical block layer. As further depicted, the extent map entries enable the extent map to identify a physical extent 232 comprising PVBN1, PVBN2, and PVBN3 and a second physical extent 234 comprising PVBN4. In this manner, the depicted structure provides a transactional, rather than a fixed, one-to-one mapping between each logical block number (extent block number) and PVBN.

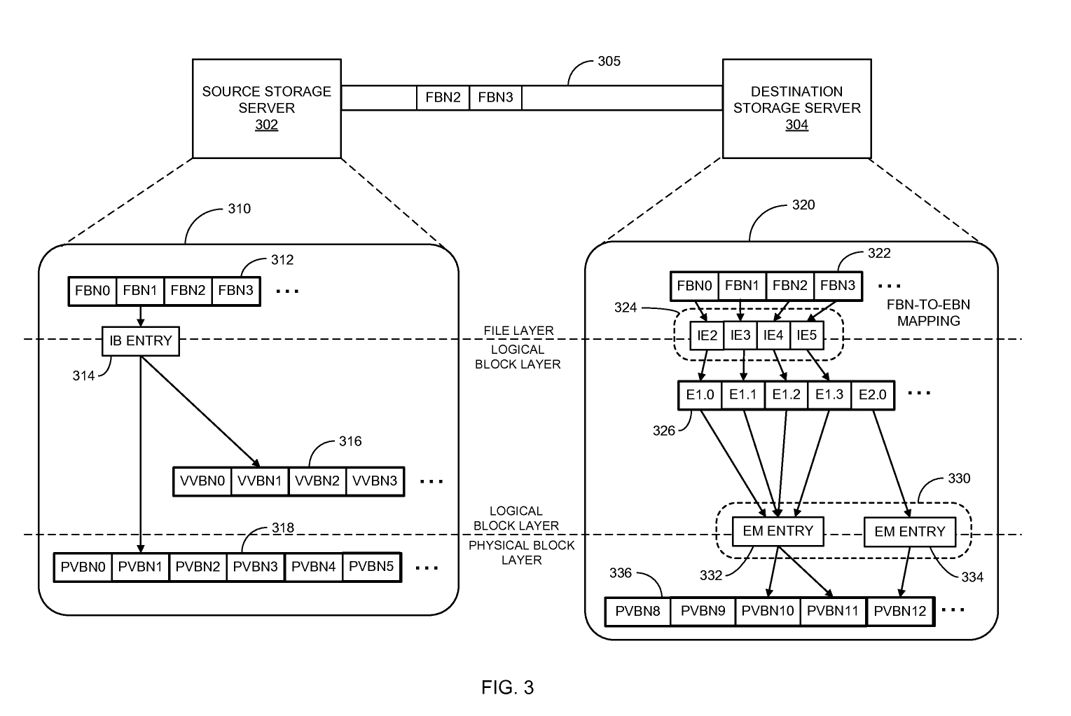

FIG. 3 is a block diagram illustrating a source storage server that may replicate data to a destination storage server that employs an extent-based file system in accordance with an aspect. Specifically, a source storage server 302 is coupled to a destination storage server 304 over a data transport channel 305 such as may be provided over a network or direct interconnect. In association with source storage server 304 is a view of memory content 310 revealing an inode-based file system structure. Similarly a view of the memory content 320 of destination storage server 304 is shown together with boundaries between the respective file layer, logical block layer, and physical block layer for each of the file system structures.

In one aspect, source and destination storage servers 302 and 304 are cooperatively configured to perform logical replication wherein data at a logical, file system level is replicated from source to destination. Such logical replication may be implemented, for instance, in a vaulting relationship in which destination storage server 304 is used to archive data generated, stored, and modified by source storage server 302. In addition to performing logical replication, storage servers 302 and/or 304 may implement a storage efficiency mechanism such as data compression and/or deduplication in order to maximize physical storage space efficiency and minimize replication-related network traffic over transport channel 305. However, due to the I/O performance tradeoffs inherent in using deduplication, and particularly in using data compression, source storage server 302 and destination storage server 304 may differ in their respective use of such storage efficiency mechanisms. For example, source storage server 302 may utilize only deduplication while inline compression is enabled for destination server 304 during logical replication operations.

As shown in FIG. 3, both source and destination servers 302 and 304 employ file volume virtualization in which one or more levels of indirection are implemented between client-visible volumes and underlying physical storage. Volume virtualization enable independent management of lower-level storage layers as multiple logical volumes can be generated, deleted, and reconfigured within the same or different physical storage containers. In addition to applying asymmetric storage efficiency techniques, source and destination storage servers 302 and 304 may employ logical rather than physical replication such that even if source and destination use the same type of file volume virtualization, the addressing mappings will differ between source and destination. In the depicted aspect, source and destination storage servers 302 and 304 utilize different file volume virtualization.

Memory content 310 shows how data is mapped from a file to physical storage media by source storage server 302. Namely, an ordered sequence of FBNs 312 is depicted such as may comprise a file, all or a portion of which may be modified and replicated to destination storage server 304. Indirect block entries, such as entry 314 may map each of FBNs 312 to a corresponding virtual volume block number (VVBN) within a VVBN container file 316. A single such mapping is expressly depicted for purposes of clarity. As further depicted, the same indirect block entry 314 that maps FBN1 to a VVBN1 also maps FBN1 to a PVBN1 in an aggregate 318 within the physical block layer.

In contrast to the virtualization and block mapping used by source in which there is a fixed, one-to-one mapping between an FBN and VVBN/PVBN pair, destination storage server 304 employs an extent-based architecture as depicted within memory content 320. The same sequence of file block numbers, FBN01, FBN1, FBN2, and FBN3 are utilized to represent a same file 322 as stored in FBN0, FBN1, FBN2, and FBN3 within FBN sequence 312. However, on the destination side, each of the FBNs are mapped into logical blocks via an indirect block 324 containing entries 1E2, 1E3, 1E4, and 1E5 in which the VVBN used by the source side are replaced with extent block numbers E1.0, E1.1, E1.2, and E1.3.

The destination side volume virtualization mechanism further includes an extent-to-PVBN map 330 that maps the extent block numbers to corresponding extents such as within extent map entries 332 and 334. As illustrated, each of extent map entries maps one or more extent block numbers to a PVBN within a destination side aggregate 336 independently of the FBN-to-EBN mapping provided by indirect block 324.

The foregoing destination side indirect block mapping and extent-to-PVBN mapping enables more efficient processing of logical replication when compression is enabled on destination storage server 304. For instance, consider an eight block file comprising FBN0-FBN7 stored on source storage server 302 as eight physical blocks addressed at PVBN0-PVBN7 with the same file stored on destination storage server 304 in compressed form as four physical blocks addressed at PVBN10-PVBN13. Suppose source blocks FBN2 and FBN3 corresponding to PVBN2 and PVBN 3 are modified and sent in a write request for replication to destination storage server 304. At the logical volume level the corresponding file blocks FBN2 and FBN3 remain mapped to logical extent blocks EBN2 and EBN3. However, mappings to the PVBNs are not directly maintained due to the compression to four PVBNs. Instead of requiring PVBN10-PVBN13 to be uncompressed to commit the write to storage, the extent-to-PVBN map 330 allocates an additional extent entry in which, assuming no compression, two new extent block numbers are assigned to the modified FBN2 and FBN3 and the extent block numbers are associated with the new extent ID.

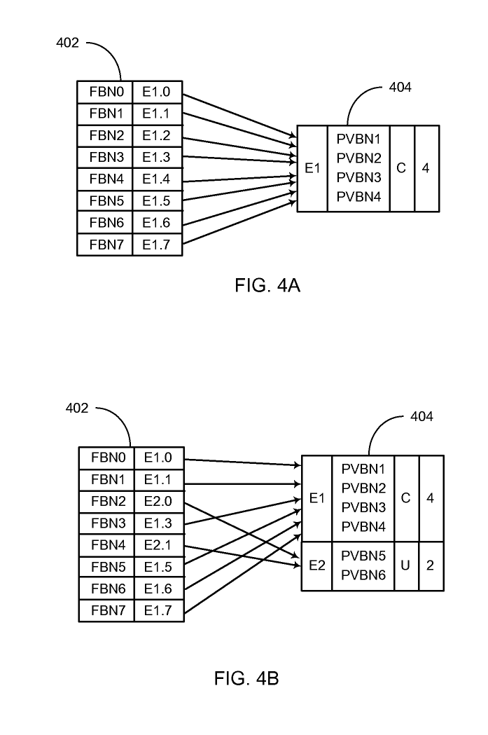

FIG. 4A is a block diagram depicting an intermediate block 402 containing intermediate block entries and an extent-to-PVBN map entry corresponding to a physical extent having compressed data blocks in accordance with an aspect. In the depicted aspect, intermediate block 402 includes eight file-to-logical volume entries in which FBN0-FBN7 are respectively associated with extent block numbers E1.0-E1.7. The one-to-one mapping between FBNs and EBNs enables a storage file system to implement logical partitioning and allocation of logical volumes. As further shown in FIG. 4A, each of the file-to-logical volume entries points (such as by an EID) to an extent map entry within an extent map 404 that associates a given physical block extent E1 to four PVBNs, PVBN1-PVBN4. The extent map entry further includes a length field specifying an extent length of four physical blocks and a compression field containing a single bit flag that identifies the extent as belonging to a compression group that has been compressed. The two-part structural mapping provided by intermediate block 402 and extent map 404 enables a portion of a file containing data that is logically addressed by E1.0-E1.7 to be partially overwritten without the need to uncompress the data addressed by PVBN1-PVBN4.

FIG. 4B is a block diagram illustrating modifications to entries within intermediate block 402 and extent map 404 that includes entries corresponding to a compressed physical extent that has been partially overwritten in accordance with an aspect. The modifications are performed in response to a write request to overwrite data previously logically addressed by E1.2 and E1.4. As shown in FIG. 4B, in response to determining that the target compression group corresponding to extent E1 is compressed, a new extent map entry is allocated to extent map 404. The new extent map entry associates extent identifier E2 with the PVBN addresses of the two modified data blocks to be written to respective locations on physical storage media. As further shown in FIG. 4B, the entries within indirect block 402 corresponding to the modified blocks have been modified to include new extent IDs that now point to the new extent E2. The FBN to EBN logical volume mapping in combination with the extent-to-PVBN mapping provides transactional decoupling and flexibility to enable compression groups to be effective overwritten without having to be decompressed.

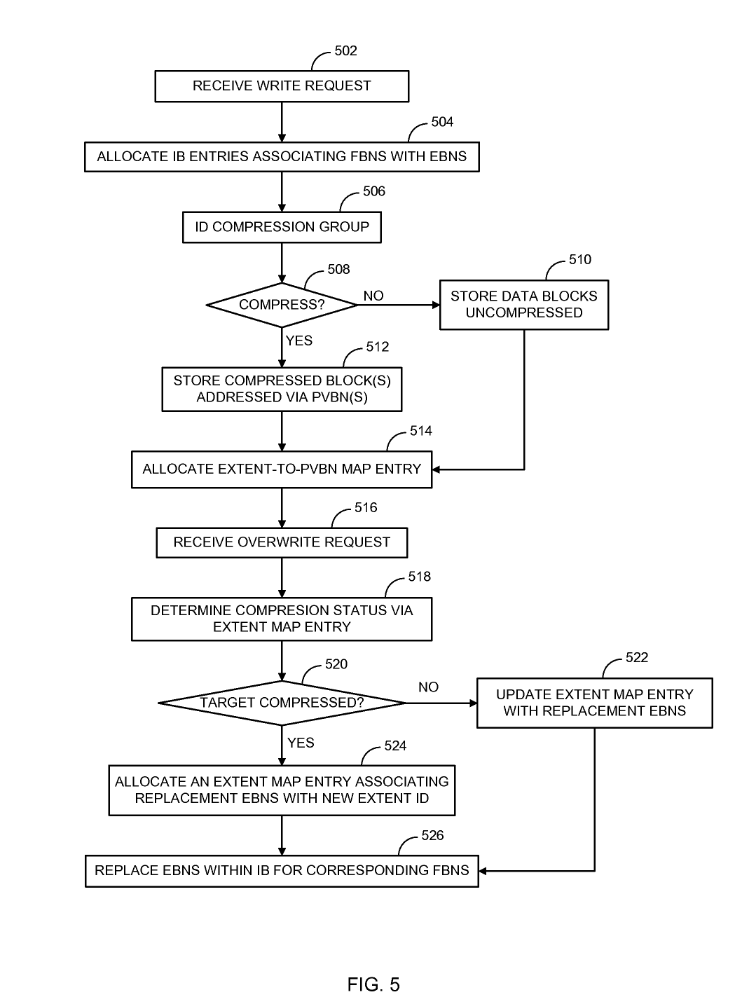

FIG. 5 is a flow diagram depicting operations and functions that may be implemented by a storage server to logically organize compressed data in accordance with an aspect. The method begins as shown at block 502 with a destination file system receiving a write request. The write request may originate from a host or local application or may be sent from another device such as a source storage server during logical replication. The write request includes multiple data blocks and specifies corresponding file block numbers that specify the sequential offset of each of the data blocks within a file. Next, at block 504, the storage server via the file system file-to-extent layer allocates an intermediate block having entries that each associate one of the received file block numbers with a respective extent block number.

In one aspect the storage server processes the write request with an inline compressing engine enabled. At block 506, the file system, in cooperation with the compression engine, identifies segments of submultiples of the data blocks that form one or more corresponding compression groups. At block 508 each of the segments of two or more data blocks are evaluated to determine compressibility based on whether sufficient bit-level repeat patterns exist among the blocks in a given compression group. For each compression group that is determined not to be compressible, the file system stores the data blocks uncompressed (block 510) at physical storage locations addressed by physical block addresses. For each compression group that is determined to be compressible, the compression engine compresses the data blocks into a smaller set of data blocks which the file system stores at physical locations addressed at physical block addresses (block 512).

In addition to storing the compressed or uncompressed blocks, the file system allocates an extent-to-PVBN map entry for each of the compression groups (block 514). An extent-to-PVBN map entry includes a field containing an extent ID that is unique within an aggregate of PVBNs. The entry further associates the extent ID with the extent block numbers assigned at block 504. At some point subsequent to writing a new file or new blocks for a file, a request to write data to modified file blocks may be received (block 516). In response to the overwrite request, the file system may read a compression flag stored with an extent map entry to determine whether the target file blocks have been compressed (block 518). In response to determining that the target blocks are not compressed within physical storage, the file system updates a corresponding extent map entry with replacement extent block numbers that will now be associated within the entry with the unchanged extent ID (blocks 520 and 522). In response to determining that the target blocks are compressed on disk, the file system allocates a new extent map entry that associates replacement extent block numbers with a new extent ID (block 524). In either case, (new extent map entry with new extent ID or replace extent block numbers only), the file system accesses the intermediate block to replace the previous extent block numbers with replacement block numbers such that each of the file block numbers from the overwrite request are respectively associated with one of the replacement extent block numbers (block 526). In the case of a newly allocated extent map entry, the intermediate block is also modified to replace the previous extent ID with the new extent ID.

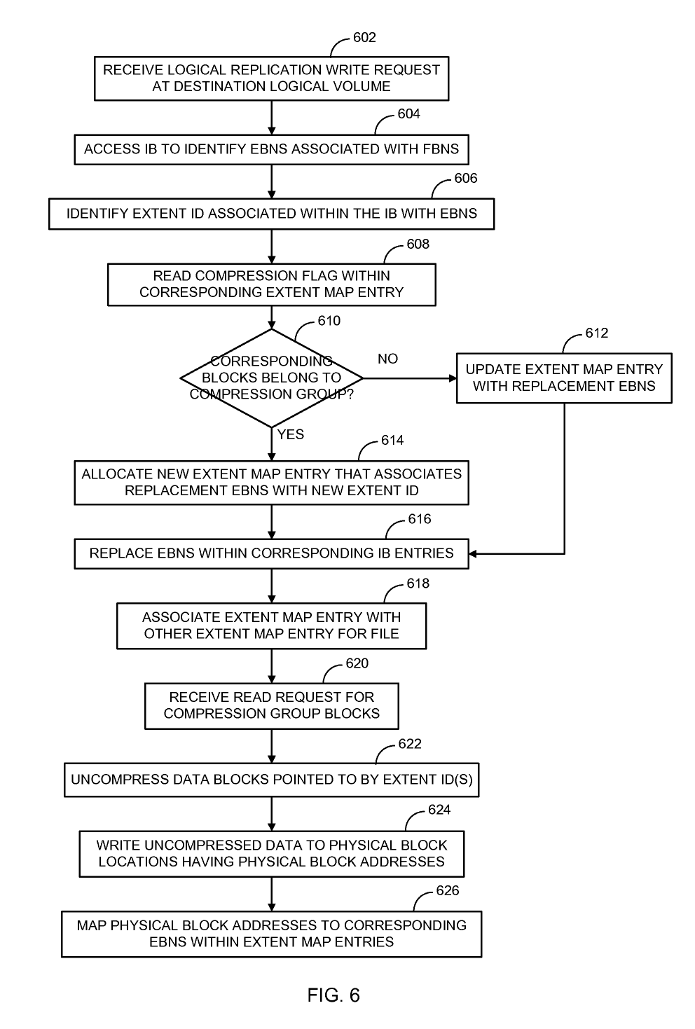

FIG. 6 is a flow diagram depicting operations and functions that may be implemented during logical replication of a source data set to a compressed destination data set in accordance with an aspect. Such logical replication may typically be coordinated between cooperating replication applications on source and destination storage servers and be performed based on specified file system consistency points. As shown at block 602, the destination server's file system receives a write request that may be formatted or otherwise configured based on a replication update file format. The write request includes data blocks and specifies associated file block numbers. In response to the write request, the file system accesses an extent-based intermediate block to identify extent block numbers that are associated, within the intermediate block, with the receive file block numbers (block 604). The file system also identifies by access to the intermediate block the extent ID associated with the identified extent block numbers (block 606).

At block 608, the file system uses the identified extent ID to access a corresponding extent map entry and reads a compression flag within the entry to determine whether the received data blocks have been compressed on the destination physical storage. In response to determining that the data blocks received in the write request are not compressed on destination server storage, the file system updates a corresponding extent map entry with replacement extent block numbers to be associated within the map entry with the unchanged extent ID (blocks 610 and 612). In response to determining that the data blocks are compressed on destination storage, the file system allocates a new extent map entry that associates replacement extent block numbers with a new extent ID (block 614). In either case, (new extent map entry with new extent ID or replace extent block numbers only), the file system accesses the intermediate block to replace the previous extent block numbers with replacement block numbers such that each of the file block numbers from the overwrite request are respectively associated with one of the replacement extent block numbers (block 616). In the case of a newly allocated extent map entry, the intermediate block is also modified to replace the previous extent ID with the new extent ID.

The file to which the overwritten data blocks may include other data blocks contained within another physical and logical extent. In such a case, and as shown at block 618, the file system associates the extent map entry for a newly created extent with the other extent map entries that map extent block numbers of other blocks of the file to the previously existing extent(s). The file system may then receive a read request for blocks within the file that span between physical extents that are each identified with respective extent IDs (block 620). In response to such a read request, the file system, in cooperation with a local compression engine, uncompresses data within the requested data blocks that are pointed to by different extend IDs (block 622). The uncompressed data is then written to physical block locations having corresponding physical block addresses (block 624). As shown at block 626, the physical block addresses are mapped to corresponding extent block numbers within the extent map entries corresponding to the different extent IDs.

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality provided as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

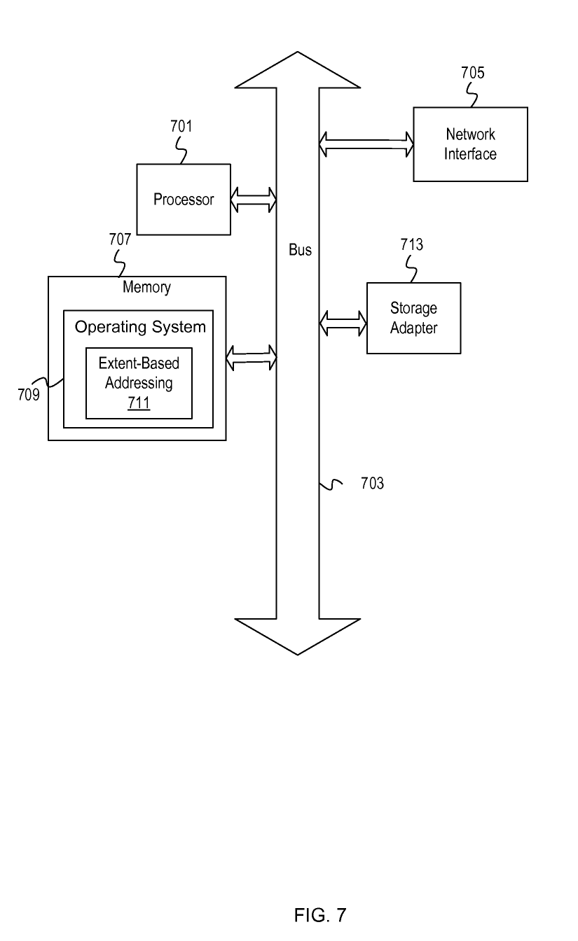

FIG. 7 depicts an example computer system that includes an extent-based file system in accordance with an embodiment. The computer system includes a processor unit 701 (possibly including multiple processors, multiple cores, multiple nodes, and/or implementing multi-threading, etc.). The computer system includes memory 707. The memory 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 703 (e.g., PCI, ISA, PCI-Express, HyperTransport® bus, InfiniBand® bus, NuBus, etc.) and a network interface 705 (e.g., a Fiber Channel interface, an Ethernet interface, an internet small computer system interface, SONET interface, wireless interface, etc.). The system also includes an extent-based addressing unit 711. The extent-based addressing unit 711 provides program structures for processing write requests include write requests incident to logical replication. Any one of the previously described functionalities may be partially (or entirely) implemented in hardware and/or on the processor unit 701. For example, the functionality may be implemented with an application specific integrated circuit, in logic implemented in the processor unit 701, in a co-processor on a peripheral device or card, etc. Further, realizations may include fewer or additional components not illustrated in FIG. 7 (e.g., video cards, audio cards, additional network interfaces, peripheral devices, etc.). The processor unit 701 and the network interface 705 are coupled to the bus 703. Although illustrated as being coupled to the bus 703, the memory 707 may be coupled to the processor unit 701.

While the aspects of the disclosure are described with reference to various implementations and exploitations, it will be understood that these aspects are illustrative and that the scope of the claims is not limited to them. In general, techniques for an object storage backed file system that efficiently manipulates namespace as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality shown as separate components in the example configurations may be implemented as a combined structure or component. Similarly, structures and functionality shown as a single component may be implemented as separate components. These and other variations, modifications, additions, and improvements may fall within the scope of the disclosure.

What is claimed is:

1. A method comprising:
receiving a first write request that includes multiple data blocks and specifies corresponding file block numbers;
accessing intermediate block entries that each associates one of the file block numbers with a respective extent block number;
compressing the data blocks into a set of one or more compressed data blocks;
storing the compressed data blocks at physical locations corresponding to physical block numbers; and
allocating, within an extent map, pointers from an extent ID to the extent block numbers, and pointers from the extent ID to the physical block numbers.

2. The method of claim 1, wherein the multiple data blocks and corresponding file block numbers belong to a file, and wherein the first write request is a request to overwrite a portion of the file, said method further comprising replacing, in the intermediate block, the extent block numbers with replacement extent block numbers such that each of the file block numbers are respectively associated with one of the replacement extent block numbers, wherein each of the replacement extent block numbers is associated within the intermediate block with the extent ID.

3. The method of claim 1, further comprising:
receiving a second write request that includes multiple data blocks and specifies corresponding file block numbers; and
in response to determining that the second write request is a request to overwrite a portion of the compressed data blocks,
allocating an extent map entry that associates replacement extent block numbers with a second extent ID; and
replacing, in the intermediate block, the extent block numbers with the replacement extent block numbers such that each of the file block numbers from the second write request are respectively associated with one of the replacement extent block numbers, wherein each of the replacement extent block numbers is associated within the intermediate block with the second extent ID.

4. The method of claim 3, further comprising storing data contained in the data blocks from the second write request at physical locations corresponding to physical block numbers, wherein the extent map entry associates the physical block numbers with the second extent ID.

5. The method of claim 1, wherein said allocating comprises allocating an extent map entry, and wherein said allocating is executed in response to assigning the data blocks to a compression group.

6. The method of claim 1, further comprising:
accessing an intermediate block that includes the intermediate block entries to identify extent block numbers that are associated within the intermediate block with the file block numbers;
determining whether the data blocks belong to a compression group based on the identified extent block numbers; and
in response to determining that the data blocks belong to a compression group,
replacing the extent block numbers with replacement extent block numbers; and
allocating a first extent map entry that associates the replacement extent block numbers with a first extent ID.

7. The method of claim 6, wherein said determining whether the data blocks belong to a compression group comprises:
identifying a second extent ID that is associated within the intermediate block with the extent block numbers; and
reading a compression flag within an extent map entry that associates the second extent ID with the extent block numbers.

8. The method of claim 6, wherein the extent block numbers are associated within the intermediate block with a second extent ID that is associated within a second extent map entry with physical block numbers corresponding to physical storage locations of data blocks within a file, said method further comprising associating, within an extent map, the first extent map entry with the second extent map entry.

9. A non-transitory machine readable medium having stored thereon instructions for performing a method, wherein the instructions comprise machine executable code which when executed by at least one machine, causes the machine to:
receive a first write request that includes multiple data blocks and specifies corresponding file block numbers;
access intermediate block entries that each associates one of the file block numbers with a respective extent block number;
compress the data blocks into a set of one or more compressed data blocks;
store the compressed data blocks at physical locations corresponding to physical block numbers; and
allocate, within an extent map, pointers from an extent ID to the extent block numbers, and pointers from the extent ID to the physical block numbers.

10. The non-transitory machine readable medium of claim 9, wherein the instructions further comprise machine executable code which when executed by at least one machine, causes the machine to:
receive a second write request that includes multiple data blocks and specifies corresponding file block numbers; and
in response to determining that the second write request is a request to overwrite a portion of the compressed data blocks,
allocate an extent map entry that associates replacement extent block numbers with a second extent ID; and
replace, in the intermediate block, the extent block numbers with the replacement extent block numbers such that each of the file block numbers from the second write request are respectively associated with one of the replacement extent block numbers, wherein each of the replacement extent block numbers is associated within the intermediate block with the second extent ID.

11. The non-transitory machine readable medium of claim 10, wherein the instructions further comprise machine executable code which when executed by at least one machine, causes the machine to store data contained in the data blocks from the second write request at physical locations corresponding to physical block numbers, wherein the extent map entry associates the physical block numbers with the second extent ID.

12. The non-transitory machine readable medium of claim 9, wherein said allocating comprises allocating an extent map entry, and wherein said allocating is executed in response to assigning the data blocks to a compression group.

13. The non-transitory machine readable medium of claim 9, wherein the instructions further comprise machine executable code which when executed by at least one machine, causes the machine to:
access an intermediate block that includes the intermediate block entries to identify extent block numbers that are associated within the intermediate block with the file block numbers;
determine whether the data blocks belong to a compression group based on the identified extent block numbers; and
in response to determining that the data blocks belong to a compression group, replace the extent block numbers with replacement extent block numbers; and
allocate a first extent map entry that associates the replacement extent block numbers with a first extent ID.

14. The non-transitory machine readable medium of claim 13, wherein said determining whether the data blocks belong to a compression group comprises:
identifying a second extent ID that is associated within the intermediate block with the extent block numbers; and
reading a compression flag within an extent map entry that associates the second extent ID with the extent block numbers.

15. The method of claim 13, wherein the extent block numbers are associated within the intermediate block with a second extent ID that is associated within a second extent map entry with physical block numbers corresponding to physical storage locations of data blocks within a file, and wherein the instructions further comprise machine executable code which when executed by at least one machine, causes the machine to associate, within an extent map, the first extent map entry with the second extent map entry.

16. A computing device comprising:
a memory comprising machine readable media that contains machine executable code;
a processor coupled to the memory, the processor configured to execute the machine executable code to cause the processor to:
receive a first write request that includes multiple data blocks and specifies corresponding file block numbers;
access intermediate block entries that each associates one of the file block numbers with a respective extent block number;
compress the data blocks into a set of one or more compressed data blocks;
store the compressed data blocks at physical locations corresponding to physical block numbers; and
allocate, within an extent map, pointers from an extent ID to the extent block numbers, and pointers from the extent ID to the physical block numbers.

17. The computing device of claim 16, wherein the instructions further comprise machine executable code which when executed by at least one machine, causes the machine to:
receiving a second write request that includes multiple data blocks and specifies corresponding file block numbers; and
in response to determining that the second write request is a request to overwrite a portion of the compressed data blocks,
allocate an extent map entry that associates replacement extent block numbers with a second extent ID; and
replace, in the intermediate block, the extent block numbers with the replacement extent block numbers such that each of the file block numbers from the second write request are respectively associated with one of the replacement extent block numbers, wherein each of the replacement extent block numbers is associated within the intermediate block with the second extent ID.

18. The computing device of claim 17, wherein the instructions further comprise machine executable code which when executed by at least one machine, causes the machine to store data contained in the data blocks from the second write request at physical locations corresponding to physical block numbers, wherein the extent map entry associates the physical block numbers with the second extent ID.

19. The computing device of claim 16, wherein the instructions further comprise machine executable code which when executed by at least one machine, causes the machine to:
access an intermediate block that includes the intermediate block entries to identify extent block numbers that are associated within the intermediate block with the file block numbers;
determine whether the data blocks belong to a compression group based on the identified extent block numbers; and
in response to determining that the data blocks belong to a compression group,
replace the extent block numbers with replacement extent block numbers; and
allocate a first extent map entry that associates the replacement extent block numbers with a first extent ID.

20. The computing device of claim 19, wherein said determining whether the data blocks belong to a compression group comprises:
identifying a second extent ID that is associated within the intermediate block with the extent block numbers; and
reading a compression flag within an extent map entry that associates the second extent ID with the extent block numbers.
